(19) United States
(12) Patent Application Publication
(10) Pub. No.: US 2015/0167818 A1
(43) Pub. Date: Jun. 18, 2015

(54) GEARING OUTPUT SUPPORTED BY BALL BEARINGS

(71) Applicant: KISS ENGINEERING, LLC., Solon, OH (US)

(72) Inventors: Merritt A. Osborn, Chagrin Falls, OH (US); James J. Hasman, Independence, OH (US)

(21) Appl. No.: 14/567,438

(22) Filed: Dec. 11, 2014

Related U.S. Application Data
(60) Provisional application No. 61/915,683, filed on Dec. 13, 2013.

(51) Int. Cl. F16H 57/02; F16H 57/08

(52) U.S. Cl. CPC F16H 57/02; F16H 57/08; F16H 2057/02086

(57) ABSTRACT

Aspects provide gear set systems that include cylindrical input gear having gear elements arrayed outwardly on a common input gear element radius from a central axis. A sprocket gear disposed about a sprocket pin has teeth disposed to mesh with the cylindrical input gear elements. An output disc body disposed about the cylindrical input gear and attached to the sprocket pin defines circular grooves on a radius from the central axis. Ball bearings are disposed between the output disc body circular grooves and respective grooves formed on a housing, wherein the ball bearings transfer an operational load of the output disc body conveyed through the output disc body circular grooves to the housing while rolling along the circular grooves during operation of the gear set system.

### BACKGROUND

Compound gearing structures, systems and methods are used to translate the input speed and/or torque of a motor element input shaft into motive characteristics required for a task at hand. Typically, this requires reducing or increasing the effective speed of a rotating input shaft, and increasing or decreasing its effective torque force properties in a desired application. Compound gearing structures are sometimes referred to as “gear sets,” “gearboxes” and “gear heads,” and still other terms will be apparent to one skilled in the art. Gear sets generally comprise housed sets of gears, shafts and bearings in a broad range of sizes, capacities and speed ratios. A user may determine the size and performance specifications and choose or design an appropriate gear set accordingly.

Conventional gearing arrangements within gear sets include spur, helical, planetary, harmonic, worm, bevel, and cycloidal systems. Choices between types may be driven by physical space requirements and tolerances associated with the application of the chosen gear set to input motor elements and output applications. In some applications, space and tolerance dimensions are at a premium, such as, for example, in small robotic or machine applications. Weight considerations may indicate the need for a lightweight gear set structure. The need to define a gear set compound gearing structure with strong and resilient materials, typically metal and metal alloy gearing and shaft structures, sometimes in combination with chain, cog belt or “silent chain” structures, requires certain minimum size and spatial dimension accommodations for the gear set as dictated by input and output element speeds and input and output torque specification requirements.

The need to physically attach and support the gear set on the input motor structure, and to support the load and torque forces inherent in the operation of the prior art gear set, may also require dedicated structural support elements that must be designed into the gear set. Such structural support elements may increase the material and space requirements associated with the gear set, and may render some gear sets too large or heavy for small space, tight tolerance and/or low weight specification applications.

### BRIEF DESCRIPTION OF THE SEVERAL VIEWS OF THE DRAWINGS

FIG. 1 is a side/front perspective view illustration of a planetary gear set according to the present invention.

FIG. 2 is a side/back perspective view illustration of the planetary gear set of FIG. 1.

FIG. 3 is a back-side view illustration of the planetary gear set of FIGS. 1 and 2.

FIG. 4 is a cross sectional view illustration of the planetary gear set of FIGS. 1, 2 and 3 taken along the lines indicated in FIG. 3.

FIG. 5 is a side/front perspective view illustration of another aspect of a gear set according to the present invention.

### DETAILED DESCRIPTION OF THE INVENTION

The present invention provides a system and method for compound gear sets wherein the load, and optionally torque, of an output plate of a gear set is supported by or transferred to a housing structure through a plurality of ball bearings disposed within grooves between opposing faces. The grooves are located on a common radius from a central axis of the gear set that is common with the axis of a central drive gear, and the bearings located therein engage the opposing faces and enable rotational movement of the output plate relative to the housing. In some aspects, no separate torque arm or support structure is required, resulting in greatly improved efficiencies in space and material.

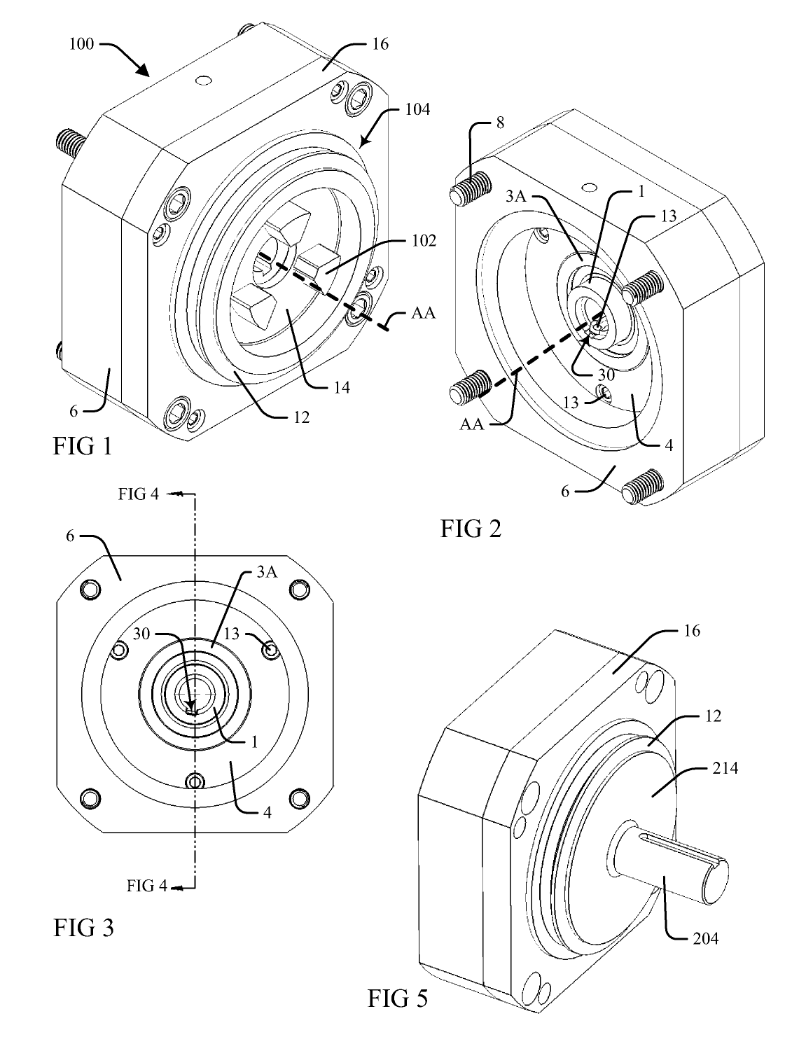

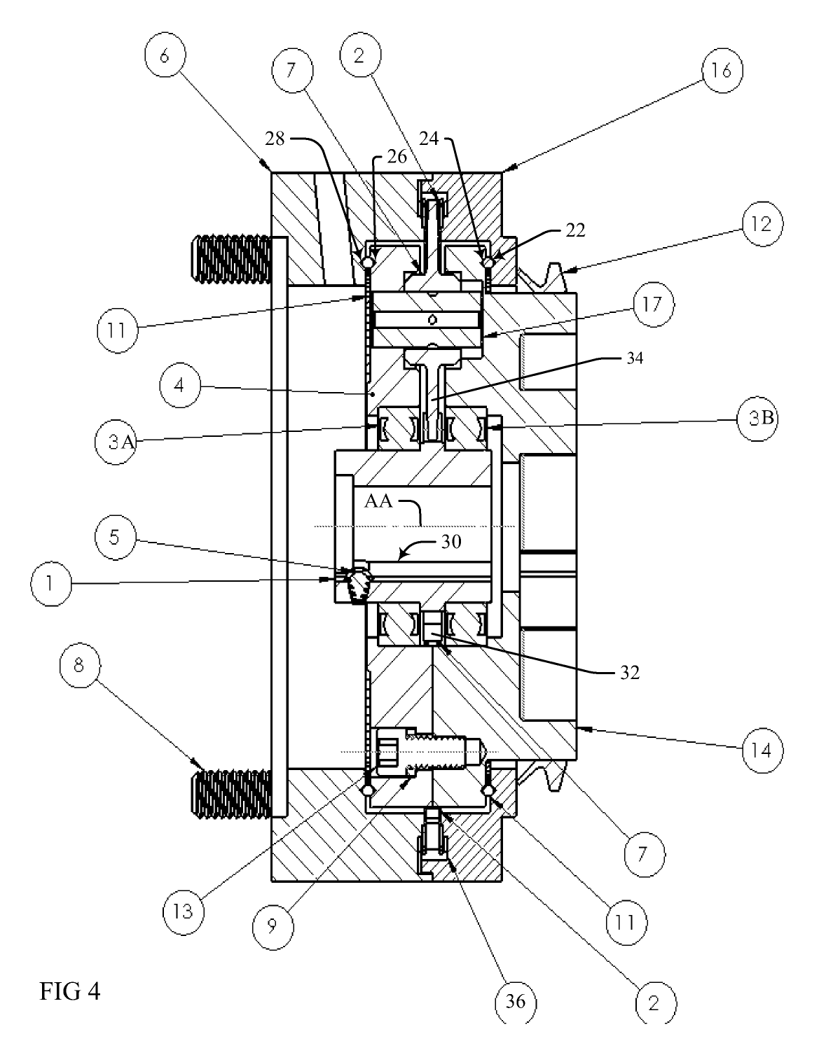

Aspects of the invention may be practiced with many types of gearing systems, including spur, helical, planetary, harmonic, worm, bevel, and cycloidal gearing. FIGS. 1 through 4 illustrate a planetary gear set 100 according to the present invention. FIG. 1 is a side/front perspective view of the gear set 100 that shows inner housing 6 and outer housing 16 elements, wherein an outer output plate disc 14 with a Lovejoy, Inc., jaw in-shear coupling 102 are apparent through a circular aperture 104 formed in the outer housing 16. FIG. 2 is a side/back perspective view of the gear set 100 wherein a sun input driving gear 1 is visible and accessible through a void or aperture formed in the inner housing 6 element. FIG. 3 is a back-side view of the gear set 100, and FIG. 4 is a cross sectional view of the gear set 100 taken along the lines indicated in FIG. 3. FIG. 5 illustrates a side/front perspective view of a variation of the planetary gear set 100 that has an alternative outer output plate disc 214 and keyed shaft projection 204 for engaging other work piece elements. An excluder seal 12 engages the outer output plates 14 and 214 and the outer housing 16 and functions to keep contaminants out of the gear set 100, and/or to keep lubrication within.

The sun gear 1 engages the output discs 4 and 14 (or 214) through a pair of radial bearings 3, namely an inner bearing 3A and an outer bearing 3B. The bearings 3A and 3B enable the sun gear 1 to rotate relative to the output plate discs 4 and 14/214 about a common axis AA, while supporting the output plate discs 4 and 14/214 on the sun gear 1 (or vice versa) via the bearings 3. The bearings 3 provide cooperative movement and/or alignment functions for the output discs 4 and 14/214 with respect to the input sun gear 1. In the present example, a pair of bearings 3 is utilized, though other aspects may use only one radial bearing 3, between the sun gear 1 and just one of the inner output disc 4 and the outer output disc 14/214. In one example, wherein the outer output disc 14/214 is within one inch of an inner housing disc element 6 (wherein the width of the inner output disc 4 is less than one inch), the inner bearing 3A is omitted and only the outer radial bearing 3B is deployed.

The sun input driving gear 1 has a plurality of gear elements 32 that are meshed with the teeth 34 of circumferentially spaced planetary sprocket gears 7. The present example has four planetary sprocket gears 7, though more or less planetary sprocket gears 7 may be practiced in a given gear set.

The planetary gears 7 rotate about circumferentially spaced drive pins 17 that are equally spaced about the central axis AA that is in common (aligned) with a central axis of the sun gear 1. The drive pins 17 are fixed at their respective ends into the outer carriage disc body 14 and the inner carriage disc body 4. The outer carriage body 14 and inner carriage body 4 are attached to each other by one or more screw 13 and lock washer 9 assemblies, thereby sandwiching the drive pins 17 and the planetary gears 7 between the outer carriage body 14/214 and inner carriage body 4.

The outer carriage output body 14/214 and inner carriage output body 4 engage the outer encasement housing structure defined by the inner 6 and outer 16 housing elements via a plurality of individual steel ball bearings 11 that are located within groves 22, 24, 26 and 28 formed in their respective facing surfaces. More particularly, the mating sets of the grooves 22 and 24, and 26 and 28, are formed on common radii from the central axis AA and have sidewalls that capture the bearings 11 and prevent them from moving inward or outward relative to the central axis AA while allowing the bearings 11 to roll along the grooves.

In the present illustrated example, the grooves 22, 24, 26 and 28 all share a common radius, and the ball bearings 11 are accordingly distributed evenly between the respective mating groove pairs 22/24 and 26/28. More particularly, one half of a total number of the individual steel ball bearings 11 are disposed and sandwiched between a groove 24 located on an outer-facing surface of the outer carriage body 14/214 and a corresponding mating groove 22 located on an inward-facing surface of the outer encasement disc housing body 16, the grooves 22 and 24 defined on a common radius from the central axis AA. The other half of the steel ball bearings 11 are sandwiched between a groove 26 located on an inner-facing surface of the inner carriage body 4 and a corresponding mating groove 28 located on an outward-facing surface of the inner encasement disc housing body 6 on the a common radius from the central axis AA. However, it will be understood that in other aspects the respective pairs of mating grooves may be located on different radii from the common central axis, and the distributions of bearings 11 within the respective mating groove assemblies will vary as needed.

A single-strand precision roller chain 2 having a plurality of rollers 36 is captured between the inner encasement disc housing body 6 and the outer encasement disc housing body 16, wherein the rollers 36 are aligned on a common radius from the central axis AA of the gear set assembly 100. The sun gear 1 has a set screw 5 positioned to engage a work piece shaft (not shown) within a keyed aperture 30 formed within the sun gear 1, as will be readily understood by one skilled in the art. The planetary gears 7 are driven into rotation about their respective pins 17 by the driving gear 1 via the meshed interaction of their respective gear elements 32 and teeth 34. In response to this rotation, the planetary gear 7 teeth 34 meshed with the ring gear chain 2 rollers 36 cause the rotating planetary gears 7 to travel along the ring gear 2.

In aspects of the invention, the gear elements or teeth 32, 34 and 36 of the respective sun gear 1 planetary sprocket gears 7 and ring gear 2 may include a variety of forms and structures selected to mesh with each other, namely at the interfaces of the elements 32 and 34, and at the interfaces of the elements 34 and 36. Examples include solid and hollow teeth, roller and fixed pins and rounded-tooth elements, including examples provided in U.S. utility patent application, Ser. No. 11/202,876, and roller chain configurations described in U.S. utility patent application Ser. No. 11/202,876.

In one example, rollers and pins are deployed as the sun gear 1 elements 32 and the ring gear 2 elements 36 for meshing with planetary gear 7 involute sprocket teeth forms 34. In some aspects, the inner 6 and outer 16 housing elements are aluminum and have generally cylindrical ring gear apertures formed on respective aperture axes that are parallel to the gear set central axis AA and located on a common radius from the central axis AA (when assembled into the gear set structure 100). The aluminum material of said inner 6 and outer 16 housing elements apertures is hard anodized, and coated or impregnated with a Teflon® coating after being hard anodized. (TEFLON is a trademark of E. I. du Pont de Nemours and Company (“Dupont”) in the United States and other countries.) Hardened cylindrical steel pins 36 having an outer radius that is smaller than an inner surface radius of the apertures are then deployed within the hardened and Teflon® coated or impregnated apertures. The pins are thereby aligned parallel to the gear set central axis AA and located on a common radius from the central axis AA to form the ring gear 2 for meshing with the planetary sprockets 7 involute gear teeth 34.

The Teflon® coating provides a slippery surface that allows the pins to freely rotate within the apertures and thereby function as cylindrical rollers in interaction with the sprocket 7 involute teeth 34. By using steel pins, the resultant structure provides more robust strength and longer service life relative to roller chain ring gears 2, while providing similar performance attributes.

One skilled in the art will appreciate that the sun gear may have a similar aluminum body and hardened steel pin structure. More particularly, one aspect of the sun gear 1 is aluminum and has a plurality of generally cylindrical ring gear apertures formed on respective aperture axes that are each parallel to the gear set central axis AA and located on a common radius from the central axis AA (when assembled into the gear set structure 100). The aluminum material about the apertures is hard anodized, and coated or impregnated with a Teflon® coating after being hard anodized, and hardened steel pins 32 are deployed within the hardened and Teflon® coated or impregnated apertures to mesh with the planetary sprockets 7 involute gear teeth 34.

Rotation of the input sun gear 1 causes one of two operational reactions in aspects of the present invention. In the first operational reaction, where either the inner housing 6 and outer housing 16 elements are fixed into a static position, for example through bolts 8 fixed into an input motor housing (not shown) of a work piece shaft (not shown) engaging the sun gear 1, rotation of the input sun gear 1 causes traveling of the planetary gear teeth 34 along the chain 2 rollers 36. This travel of the planetary gears 7 responsively drives their respective pins 17 to rotate (or “orbit”) about the central “sun” driver 1 and the central axis AA. The orbit of the pins 17 about the driver 1 thereby drives the outer output disc 14/214 and the inner output disc 4 bodies at a reduced speed and increased torque relative to the rotational speed and torque of the input driving gear 1. The reduced speed and increased torque are conveyed through the Lovejoy jaw 102 or the keyed shaft 204 of the outer output disc 14/214 to a work piece attached thereto (not shown), to produce a desired output torque and speed transformation, as is well known to one skilled in the art.

In an alternative second operational reaction, the output discs 4 and 14/214 may instead be fixed into a static position with respect to an input motor housing or other structure, which correspondingly fixes the planetary pins 17 into a static position relative to the central axis AA. Rotation of the input sun gear 1 in this configuration causes the sun gear 1 gear elements 32 to drive the planetary gears 7 into rotation about their respective pins 17 via interaction of the enmeshed planetary gear 7 teeth 34 and sun gear 1 elements 32. The rotation of the planetary gear 7 teeth 34 responsively drives the outer ring gear 2 via interaction with the ring gear pins or rollers 36, and correspondingly the inner housing 6 and outer housing 16 elements affixed thereto, into an “orbital” motion about the central axis AA at a reduced speed and increased torque relative to rotation of the input driving gear 1. The reduced speed and increased torque may be conveyed through an output element structure (not shown) attached to either or both of the inner housing 6 and outer housing 16 elements, which may, therefore, engage another gear element to produce the desired output torque and speed transformation, as will be readily apparent in one skilled in the art.

It will also be apparent to one skilled in the art that the input and output functions described thus far can be reversed, with work piece rotation of the output discs 4 and 14/214 in the first alternative, or the inner housing 6 and outer housing 16 elements in the second alternative, thereby translated into an output of increased rotational speed and decreased torque via rotation of the sun gear 1 in response thereto.

As is also readily apparent to one familiar with planetary gearing, alternative output torque forces and output speeds may be correspondingly selected through the selection of affixing output elements (the Lovejoy jaw 102, keyed shaft 204, or other output element) to either of the output discs 4 and 14/214, in contrast to affixing to either of the inner housing 6 and outer housing 16 elements, for the same input speed and torque as conveyed by the input sun gear 1. More specifically, the same rotational input speed and torque conveyed by the sun gear 1 will produce a faster rotational output speed and lower output torque when an output element is attached to output discs 4 and 14/214 (and the inner housing 6 and outer housing 16 elements are fixed into a static position relative to the input motor work piece), than where an output element is attached to the inner housing 6 and outer housing 16 elements and the output discs 4 and 14/214 are instead fixed into a static position relative to the input motor work piece.

The steel ball bearings 11 and the outer radial bearing 3B, (and where deployed, the inner radial bearing 3A) function as a torque arm for the gear set assembly 100 in supporting the rotating set of output discs 4 and 14/214 relative to the inner housing 6 and outer housing 16 elements and to the sun gear 1 when said outer housing elements 6 and 16 are fixed to a work piece housing (for example, via the bolts 8). The steel ball bearings 11 transfer torque, load and support forces from the faces of the output discs 4 and 14/214 directly to the faces of the outer housing elements 6 and 16, obviating the need for support brackets or other structures to support over hung loads imparted to the outer output disc 14/214, for example as imparted to the gear set through the Lovejoy jaw 102 or keyed shaft 204 elements. Where the sun gear 1 is attached directly to an input motor shaft, torque and overhung loads may also be imparted to the input shaft from the output disc element 14/214 via the radial bearings 3A and/or 3B, further obviating the need for additional torque arm or support structures.

By obviating support arms and other overhung load bearing structures, the gear set 100 may be deployed and used in a space-efficient manner, including within applications that may otherwise be foreclosed as having space tolerances too small for additional support arms and brackets. In one example of the gear set 100 illustrated in FIGS. 1 through 4, two hundred and seventy two (272), 3/32-inch diameter steel ball bearings 11 are disposed within the grooves 22, 24, 26 and 28, one half sandwiched between groove 24 and mating groove 22, and the other half between groove 26 and mating groove 28. The outer housing elements 6 and 16 have a total outer width dimension of about 1.955 inches and a total outer radius dimension from the central axis AA of about 3.3 inches. The width of the sun gear 1 is about 1.325 inches and is offset from the inner-most surface of the inner housing 6 by about 0.54 inch, enabling speed transformation applications on a short motor shaft length. In one exemplary application for a motor shaft with a 0.625 inch outside diameter, a 0.187 inch keyway and a 2.06 inches shaft length, the gear set 100 is interfaced with the input motor and shaft through a National Electrical Manufacturers Association (NEMA) 56-C mounting and performs a four or five-to-one speed reduction on an anticipated 1750 RPM input from the input shaft.

The use of the roller chain or steel pins within Teflon® coated/impregnated apertures for the outer ring gear 2 enables the gear set 100 to be an “uncased” gearhead assembly, in one aspect as roller chain may be impregnated with its own lubricant as is well known in the art. This removes the requirement to encase the gearhead assembly 100 in order to contain lubricants, such as gear oils, which allows for substantial reduction in the cost of manufacturing the gear set 100, resulting in greatly increased production efficiencies over prior art gear sets. However, the seal 12 also provides for an encasement of the gearhead assembly 100 that contains lubricants, gear oils, etc., within the gear set 100 and also keeps out outside contaminants.

While several embodiments of this invention have been shown and described, various adaptations and modifications can be made without departing from the scope of the invention as defined in the appended claims.

What is claimed is:

1. A system, comprising:
a cylindrical input gear comprising a plurality of round gear elements that are arrayed outwardly on a common input gear element radius from a central axis;
a sprocket gear disposed about a sprocket pin and comprising a plurality of involute teeth that are disposed to mesh with the cylindrical input gear round gear elements, wherein the sprocket gear freely rotates about the sprocket pin;
an inner output disc body disposed about the cylindrical input gear and attached to one end of the sprocket pin, the inner output disc body defining an inner output disc body circular groove on a first groove radius from the central axis within a plane normal to the central axis and facing inward;
an outer output disc body disposed about the cylindrical input gear and attached to another remaining end of the sprocket pin, the outer output disc body defining an outer output disc body circular groove on a second groove radius from the central axis within a plane normal to the central axis and facing outward, the inner output disc body and the outer output disc body encompassing the sprocket gear and the cylindrical input gear;
an outer housing encompassing the cylindrical input gear, the sprocket gear, the inner output disc body and the outer output disc body, the outer housing comprising a plurality of ring gear round gear elements that are each disposed on a ring gear radius from the central axis to mesh with the sprocket gear involute teeth, the outer housing defining an outward facing inner housing circular groove on the first groove radius from the central axis within a plane normal to the central axis and aligning with the inner output disc body circular groove, and the outer housing defining an inward facing outer housing circular groove on the second groove radius from the central axis within a plane normal to the central axis and aligning with the outer output disc body circular groove;
a first plurality of ball bearings disposed between the outward facing inner housing circular groove and the inner output disc body circular groove, wherein the first plurality of ball bearings transfer an operational load of the inner output disc body conveyed through the inner output disc body circular groove to the housing via the outward facing inner housing circular groove while rolling along the outward facing inner housing circular groove and the inner output disc body circular groove during operation of the gear set; and
a second plurality of ball bearings disposed between the inward facing inner housing circular groove and the outer output disc body circular groove; wherein the second plurality of ball bearings transfer an operational load of the outer output disc body conveyed through the outer output disc body circular groove to the housing via the inward facing inner housing circular groove while rolling along the inward facing inner housing circular groove and the outer output disc body circular groove during operation of the gear set.

2. The system of claim 1, wherein the operational loads transferred to the outer housing through the first plurality of ball bearings and the second plurality of bearings comprise a total operative torque load of the inner output disc body and the outer output disc body.

3. The system of claim 2, wherein rotation of the cylindrical input gear about the central axis at a first motor shaft input gear revolution speed and a first input torque drives the sprocket gear into rotation about the sprocket pin in response to meshing of the cylindrical input gear round gear elements with the sprocket gear involute teeth;
wherein the rotation of the sprocket gear about the sprocket pin causes the sprocket gear involute teeth to engage the ring gear round gear elements and responsively drive the sprocket gear pin and the inner output disc body and the outer output disc body that are attached thereto into rotation about the central axis at an output revolution speed that is less than the input revolution speed, and at an output element torque that is greater than the input torque.

4. The system of claim 3, wherein the outer housing is an aluminum body, the system further comprising:
a plurality of generally cylindrical ring gear apertures formed on respective aperture axes that are each parallel to and spaced from the central axis on a ring gear radius, wherein inner surfaces of the ring gear apertures are hard anodized and coated or impregnated with a Teflon® coating; and
wherein the ring gear round gear elements are steel pins disposed within the ring gear apertures.
